(19) United States
(12) Patent Application Publication
(10) Pub. No.: US 2014/0028185 A1
(43) Pub. Date: Jan. 30, 2014

(54) POWER SUPPLY CIRCUIT

(71) Applicant: Funai Electric Co., Ltd., Osaka (JP)

(72) Inventor: Yukikazu NOBATA, Osaka (JP)

(73) Assignee: FUNAI ELECTRIC CO., LTD.

(21) Appl. No.: 13/937,303

(22) Filed: Jul. 9, 2013

(30) Foreign Application Priority Data
Jul. 30, 2012 (JP) 2012-168712

(51) Int. Cl. H05B 37/02; H05B 33/08

(52) U.S. Cl. CPC H05B 37/02; H05B 33/0824
USPC 315/51

(57) ABSTRACT

A power supply circuit includes a rectifying circuit, a transformer, and a current controller. The rectifying circuit is configured to rectify power of an AC power supply and supply the power to a light source. The transformer is electrically disposed between the AC power supply and the rectifying circuit. The transformer includes a primary winding and an auxiliary winding. The current controller is configured to adjust an amount of current flowing to the light source by detecting a voltage signal of the auxiliary winding and a signal based on the current flowing to the light source.

### CROSS-REFERENCE TO RELATED APPLICATIONS

This application claims priority to Japanese Patent Application No. 2012-168712 filed on Jul. 30, 2012. The entire disclosure of Japanese Patent Application No. 2012-168712 is hereby incorporated herein by reference.

### BACKGROUND

1. Field of the Invention

The present invention generally relates to a power supply circuit. More specifically, the present invention relates to a power supply circuit equipped with a rectifying circuit.

2. Background Information

A power supply circuit equipped with a rectifying circuit was known in the past (see Japanese Laid-Open Patent Application Publication No. 2004-39563 (Patent Literature 1), for example).

The above-mentioned Patent Literature 1 discloses that a discharge lamp device (power supply circuit) includes a rectifying circuit, a power feed circuit, a drive circuit for AC drive of the discharge lamp, a detecting circuit for detecting the current flowing to the discharge lamp, and a control circuit (current controller) for controlling the drive circuit based on the detected current flowing to the discharge lamp. With this discharge lamp device, the power from an AC power supply is rectified by the rectifying circuit and then inputted to the power feed circuit. Power is fed from the power feed circuit to the drive circuit, and the discharge lamp is AC-driven by the drive circuit. Also, this discharge lamp device is configured so that any arc abnormality (arc flicker, etc.) between electrodes of the discharge lamp is detected by detecting the current flowing to the discharge lamp. If an arc abnormality is detected, then the amount of current inputted to the discharge lamp is adjusted by the control circuit (current controller) and the drive circuit, which suppresses flickering that is attributable to an arc abnormality.

### SUMMARY

It has been discovered that a fluctuation component (ripple component) originating in the AC power supply occurs in the power rectified by the rectifying circuit, and that fluctuation also occurs in the power fed to the discharge lamp. Therefore, the discharge lamp may flicker. Furthermore, the discharge lamp device (power supply circuit) discussed in the above-mentioned Patent Literature 1 is configured to suppress the flickering that originates in the arc abnormalities. However, it has been discovered that a potential problem is the inability to suppress flickering that originates in the fluctuation component of the AC power supply. It has also been discovered that the fluctuation component of the AC power supply is reduced by providing a capacitor on the output side of the rectifying circuit separately from the current controller (control circuit). However, it has also been discovered that, for fluctuation of the AC power supply to be sufficiently reduced, the capacity of the capacitor ends up being large, which results in a new problem in that the power supply circuit become larger.

One object of the present disclosure is to provide a power supply circuit with which flickering originating in the fluctuation component of the AC power supply can be suppressed while not making the circuit any larger.

In view of the state of the know technology, a power supply circuit includes a rectifying circuit, a transformer, and a current controller. The rectifying circuit is configured to rectify power of an AC power supply and supply the power to a light source. The transformer is electrically disposed between the AC power supply and the rectifying circuit. The transformer includes a primary winding and an auxiliary winding. The current controller is configured to adjust an amount of current flowing to the light source by detecting a voltage signal of the auxiliary winding and a signal based on the current flowing to the light source.

Other objects, features, aspects and advantages of the present disclosure will become apparent to those skilled in the art from the following detailed description, which, taken in conjunction with the annexed drawings, discloses a preferred embodiment of a power supply circuit.

### BRIEF DESCRIPTION OF THE DRAWINGS

Referring now to the attached drawings which form a part of this original disclosure:

FIG. 1 is a side elevational view of an LED bulb in accordance with one embodiment; and

FIG. 2 is a circuit diagram of a power supply circuit of the LED bulb illustrated in FIG. 1.

### DETAILED DESCRIPTION OF EMBODIMENTS

A preferred embodiment will now be explained with reference to the drawings. It will be apparent to those skilled in the art from this disclosure that the following descriptions of the embodiment are provided for illustration only and not for the purpose of limiting the invention as defined by the appended claims and their equivalents.

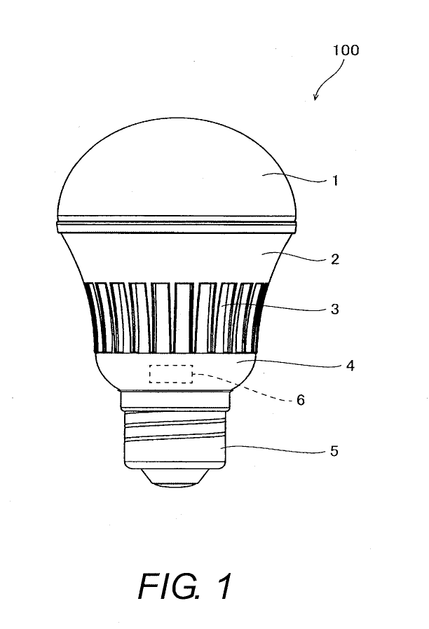

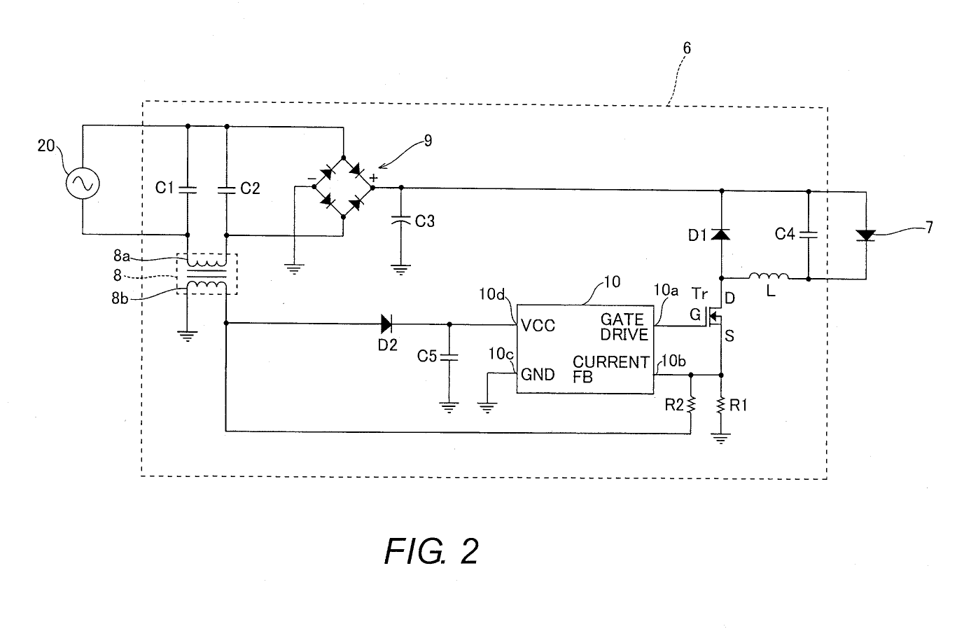

The configuration of a power supply circuit 6 in accordance with one embodiment will be described through reference to FIGS. 1 and 2.

As shown in FIG. 1, an LED bulb 100 (e.g., illumination device) mainly includes a hemispherical cover lens 1, a heat sink 2, a cylindrical casing 3, a lower cap 4, a socket receiver 5, the power supply circuit 6, and an LED element 7 (see FIG. 2). The LED element 7 is an example of a “light source” of the present disclosure. The power supply circuit 6 is electrically coupled to the LED element 7.

As shown in FIG. 2, the power supply circuit 6 includes a transformer 8, a rectifying circuit 9, and a current controlling IC 10. In this embodiment, the transformer 8 includes a filter winding 8a (filter-use winding or primary winding) for eliminating noise from the power of an AC power supply 20, and an auxiliary winding 8b (secondary winding). The filter winding 8a is an example of the “primary winding” of the present disclosure. The current controlling IC 10 is an example of the “current controller” of the present disclosure.

The rectifying circuit 9 includes a diode bridge, and is configured so that the power of the AC power supply 20 is inputted. The rectifying circuit 9 is also configured so that the power rectified by the rectifying circuit 9 is supplied to the LED element 7. Also, capacitors C1 and C2 are provided in parallel with the rectifying circuit 9 between the AC power supply 20 and the rectifying circuit 9. One electrode of the capacitor C1 is connected to the AC power supply 20 and the rectifying circuit 9, and the other electrode is connected to one end of the filter winding 8a and the AC power supply 20. One electrode of the capacitor C2 is connected to the AC power supply 20 and the rectifying circuit 9, and the other electrode is connected to the other end of the filter winding 8a and the rectifying circuit 9. The capacitors C1 and C2 have the function of removing part of the fluctuation component (ripple component) of the AC power supply 20 (smoothing), but does not remove all of the fluctuation component.

A capacitor C3 is provided on the output side of the rectifying circuit 9. The capacitor C3 includes an electrolytic capacitor. One electrode of the capacitor C3 is connected to the rectifying circuit 9, the cathode side of a diode D1 (discussed below), one electrode of a capacitor C4, and the anode side of the LED element 7. The other electrode of the capacitor C3 is grounded. The capacitor C3 has the function of removing part of the fluctuation component (ripple component) of the power outputted from the rectifying circuit 9 (smoothing), but does not remove all of the fluctuation component. Specifically, the power supplied from the rectifying circuit 9 to the LED element 7 includes a fluctuation component.

The diode D1, the capacitor C4, and a reactor L are provided between the rectifying circuit 9 and the LED element 7. The cathode side of the diode D1 is connected to the rectifying circuit 9, one electrode of the capacitor C3, one electrode of the capacitor C4, and the anode side of the LED element 7. The anode side of the diode D1 is connected to a drain D of a transistor Tr (discussed below) and the reactor L. One electrode of the capacitor C4 is connected to the rectifying circuit 9, one electrode of the capacitor C3, the cathode side of the diode D1, and the anode side of the LED element 7. The other electrode of the capacitor C4 is connected to the cathode side of the LED element 7 and the reactor L. The diode D1, the capacitor C4, and the reactor L form a back converter (step-down chopper).

The transistor Tr is provided between the diode D1 (reactor L) and the current controlling IC 10. The drain D of the transistor Tr is connected to the anode side of the diode D1 and the reactor L. The gate G of the transistor Tr is connected to an electric terminal 10a (GATE DRIVE) of the current controlling IC 10. The source S of the transistor Tr is connected to one side of a resistor R1 for detecting the current flowing to the LED element 7, and to an electric terminal 10b (CURRENT FB or second terminal) of the current controlling IC 10. The other side of the resistor R1 is grounded. The current flowing to the LED element 7 (the signal based on the current flowing to the LED element 7) is inputted via the transistor Tr to the terminal 10b (CURRENT FB) of the current controlling IC 10. An electric terminal 10c (GND) of the current controlling IC 10 is grounded.

The transformer 8 is provided between the AC power supply 20 and the rectifying circuit 9. One end of the filter winding 8a of the transformer 8 is connected to the AC power supply 20, and the other end is connected to the rectifying circuit 9. One end of the auxiliary winding 8b of the transformer 8 is grounded. In this embodiment, the other end of the auxiliary winding 8b is connected via a resistor R2 to the terminal 10b (CURRENT FB) of the current controlling IC 10. The resistor R2 has the function of adjusting the size of the voltage signal of the auxiliary winding 8b inputted to the current controlling IC 10. The resistance of the resistor R2 is adjusted so that the fluctuation component of the voltage signal of the auxiliary winding 8b inputted to the current controlling IC 10 and the fluctuation component of the signal based on the current flowing to the LED element 7 (the current inputted to the terminal 10b of the current controlling IC 10 via the transistor Tr) cancel each other out.

The other end of the auxiliary winding 8b is connected via a diode D2 to an electric terminal 10d (VCC or first terminal) of the current controlling IC 10. Specifically, in this embodiment, the power of the AC power supply 20 is converted (stepped down) by the auxiliary winding 8b of the transformer 8. The stepped-down voltage is inputted to the terminal 10d as voltage for driving the current controlling IC 10, separately from the voltage signal of the auxiliary winding 8b detected in order to adjust the size of the current flowing to the LED element 7 (the signal inputted to the terminal 10b (CURRENT FB) of the current controlling IC 10). A capacitor C5 is provided between the diode D2 and the current controlling IC 10.

Also, in this embodiment, the current controlling IC 10 (the terminal 10b, CURRENT FB) is configured so that the voltage signal of the auxiliary winding 8b is superposed with a signal based on the current flowing to the LED element 7. In other words, the voltage signal of the auxiliary winding 8b is superposed with the signal based on the current flowing to the LED element 7 at the terminal 10b of the current controlling IC 10. The current controlling IC 10 is also configured so that the amount of current flowing to the LED element 7 is adjusted by detecting the voltage signal of the auxiliary winding 8b and the signal based on the current flowing to the LED element 7. In other words, the current controlling IC 10 adjusts the amount of current flowing to the LED element 7 by detecting the voltage signal of the auxiliary winding 8b and the signal based on the current flowing to the LED element 7. Specifically, the current controlling IC 10 is configured such that the amount of current flowing to the LED element 7 is subjected to feedforward control based on the voltage signal of the auxiliary winding 8b. Furthermore, the current controlling IC 10 is configured such that the amount of current flowing to the LED element 7 is subjected to feedback control based on the signal based on the current flowing to the LED element 7. The current controlling IC 10 is also configured such that when the voltage signal of the auxiliary winding 8b and the signal based on the current flowing to the LED element 7 have become large, the current flowing to the LED element 7 is adjusted to be smaller. Furthermore, the current controlling IC 10 is also configured such that when the voltage signal of the auxiliary winding 8b and the signal based on the current flowing to the LED element 7 have become small, the current flowing to the LED element 7 is adjusted to be larger. More specifically, the oscillation of a signal (such as a PWM signal) inputted from the terminal 10a (GATE DRIVE) of the current controlling IC 10 to the gate G of the transistor Tr is adjusted by the current controlling IC 10 so that the current flowing to the LED element 7 will have the desired value.

As discussed above, in this embodiment, the current controlling IC 10 is provided for adjusting the amount of current flowing to the LED element 7 by detecting the voltage signal of the auxiliary winding 8b and the signal based on the current flowing to the LED element 7. Therefore, the current flowing to the LED element 7 can be adjusted so as to reduce not only the fluctuation component of the current flowing to the LED element 7, but also the fluctuation component of the voltage of the auxiliary winding 8b (AC power supply 20). This suppresses flickering that originates in the fluctuation component of the AC power supply 20. Also, flickering that originates in the fluctuation component of the AC power supply 20 can be suppressed by the current controlling IC 10. Thus, the power supply circuit 6 can be kept from becoming larger while still using the current controlling IC 10 to suppress flickering that originates in the fluctuation component of the AC power supply 20, as opposed to when a relatively large capacitor is provided separately from the current controlling IC 10 on the output side of the rectifying circuit 9 to reduce the fluctuation component of the AC power supply 20.

Also, as discussed above, in this embodiment the current controlling IC 10 is configured such that the voltage of the auxiliary winding 8b is inputted as voltage for driving the current controlling IC 10, independently from the voltage signal of the auxiliary winding 8b detected in order to adjust the amount of current flowing to the LED element 7. If the voltage on the output side of the rectifying circuit 9, for example, is stepped down via a resistor, and this voltage is used to drive the current controlling IC 10, then there is greater power loss due to the heat generated by the resistor. However, in this embodiment, since the voltage of the AC power supply 20 can be efficiently lowered by the transformer 8 (auxiliary winding 8b), and this voltage used to drive the current controlling IC 10, the power loss can be reduced.

Also, as discussed above, in this embodiment the current controlling IC 10 is configured such that the current flowing to the LED element 7 is adjusted lower when the voltage signal of the auxiliary winding 8b and the signal based on the current flowing to the LED element 7 become larger. Furthermore, the current controlling IC 10 is configured such that the current flowing to the LED element 7 is adjusted higher when the voltage signal of the auxiliary winding 8b and the signal based on the current flowing to the LED element 7 become smaller. With this configuration, the fluctuation component of the current flowing to the LED element 7 and the fluctuation component of the voltage of the auxiliary winding 8b (AC power supply 20) can be easily reduced.

Also, as discussed above, in this embodiment the current controlling IC 10 is configured such that the voltage signal of the auxiliary winding 8b and the signal based on the current flowing to the LED element 7 are superposed and inputted. With this configuration, the fluctuation component of the voltage signal of the auxiliary winding 8b and the fluctuation component of the signal based on the current flowing to the LED element 7 cancel each other out. Therefore, a signal in which the fluctuation component has been reduced can be inputted to the current controlling IC 10. As a result, the current flowing to the LED element 7 can be accurately adjusted so as to reduce the fluctuation component of the current flowing to the LED element 7 and the fluctuation component of the voltage of the auxiliary winding 8b (AC power supply 20).

Also, as discussed above, in this embodiment the resistor R2 is provided between the auxiliary winding 8b and the current controlling IC 10, for adjusting the size of the voltage signal of the auxiliary winding 8b inputted to the current controlling IC 10. Consequently, the fluctuation component of the voltage signal of the auxiliary winding 8b inputted to the current controlling IC 10 and the fluctuation component of the signal based on the current flowing to the LED element 7 can be easily cancelled out by adjusting the resistance of the resistor R2.

Also, as discussed above, in this embodiment the transformer 8 is configured so as to include the filter winding 8a for removing noise from the AC power supply 20. Consequently, noise in the AC power supply 20 can be more easily eliminated by the filter winding 8a of the transformer 8.

Also, as discussed above, in this embodiment the LED element 7 is provided to the LED bulb 100. The LED bulb 100 here takes up less space for mounting the element. In this embodiment, the fluctuation component of the current flowing to the LED element 7 and the fluctuation component of the voltage of the auxiliary winding 8b (AC power supply 20) are reduced by the current controlling IC 10, which keeps the device from becoming larger. Therefore, flickering can be suppressed even with the LED bulb 100 that takes up less space for mounting the element.

The embodiment disclosed herein is just an example in all respects, and should not be considered limiting in nature. The scope of the present invention is indicated by the claims rather than the above embodiment, and all modifications and variations belonging to a scope and meaning equivalent to the claims fall within the scope of the present invention.

For example, in the above embodiment, flickering of the LED element 7 is suppressed by adjusting the current flowing to the LED element 7. However, the present invention is not limited to this. For example, flickering of a light source other than the LED element 7 can be suppressed by adjusting the current flowing to the light source.

Also, in the above embodiment, the LED element 7 is provided to the LED bulb 100. However, the present invention is not limited to this. For example, an LED element can be provided to a straight-tube LED lamp (or LED tube light) having fluorescent lamp shape.

Also, in the above embodiment, the amount of current flowing to the LED element 7 is adjusted by the current controlling IC 10. However, the present invention is not limited to this. For example, the amount of current flowing to the LED element 7 can be adjusted by an IC or other circuit other than the current controlling IC 10.

Also, in the above embodiment, the voltage signal of the auxiliary winding 8b and the signal based on the current flowing to the LED element 7 are superposed and inputted to the current controlling IC 10. However, the present invention is not limited to this. For example, the voltage signal of the auxiliary winding 8b and the signal based on the current flowing to the LED element 7 can be inputted separately to the current controlling IC 10.

The power supply circuit in one aspect comprises a rectifying circuit for rectifying the power of an AC power supply and supplying it to a light source, a transformer that is provided between the AC power supply and the rectifying circuit and that includes a primary winding and an auxiliary winding, and a current controller that adjusts the amount of current flowing to the light source by detecting a voltage signal of the auxiliary winding and a signal based on the current flowing to the light source.

With the power supply circuit pertaining to this aspect, the current controller is provided that adjusts the amount of the current flowing to the light source by detecting the voltage signal of the auxiliary winding and the signal based on the current flowing to the light source. Therefore, the current flowing to the light source can be adjusted so as to reduce not only the fluctuation component of the current flowing to the light source, but also the fluctuation component of the voltage of the auxiliary winding (AC power supply). This suppresses flickering that originates in the fluctuation component of the AC power supply. Also, flickering that originates in the fluctuation component of the AC power supply can be suppressed by the current controller. Therefore, the power supply circuit can be kept from becoming larger while still using the current controller to suppress flickering that originates in the fluctuation component of the AC power supply, as opposed to when a relatively large capacitor is provided separately from the current controller to reduce the fluctuation component of the AC power supply.

With the power supply circuit pertaining to the above aspect, the current controller is further configured such that the voltage of the auxiliary winding is inputted as voltage for driving the current controller, independently from the voltage signal of the auxiliary winding detected for adjusting the amount of current flowing to the light source. If the voltage on the output side of the rectifying circuit, for example, is stepped down via a resistor, and this voltage is used to drive the current controller, then there is greater power loss due to the heat generated by the resistor. However, with the power supply circuit pertaining to this aspect, the voltage of the AC power supply can be efficiently lowered by the transformer (auxiliary winding), and this voltage can be used to drive the current controller. Thus, the power loss can be reduced.

With the power supply circuit pertaining to the above aspect, the current controller is further configured such that the current flowing to the light source is adjusted lower or decreased while the voltage signal of the auxiliary winding and the signal based on the current flowing to the light source become larger or increase. Furthermore, the current controller is configured such that the current flowing to the light source is adjusted higher or increased while the voltage signal of the auxiliary winding and the signal based on the current flowing to the light source become smaller or decrease. With this configuration, the fluctuation component of the current flowing to the light source, and the fluctuation component of the voltage of the auxiliary winding (AC power supply) can be easily reduced.

With the power supply circuit pertaining to the above aspect, the current controller is further configured such that the voltage signal of the auxiliary winding and the signal based on the current flowing to the light source are superposed and inputted. With this configuration, the fluctuation component of the voltage signal of the auxiliary winding and the fluctuation component of the signal based on the current flowing to the light source cancel each other out. Therefore, a signal in which the fluctuation component has been reduced can be inputted to the current controller. As a result, the current flowing to the light source can be accurately adjusted so as to reduce the fluctuation component of the current flowing to the light source and the fluctuation component of the voltage of the auxiliary winding (AC power supply).

With the power supply circuit pertaining to the above aspect, the power supply circuit further comprises a resistor that is electrically disposed between the auxiliary winding and the current controller, for adjusting the size of the voltage signal of the auxiliary winding inputted to the current controller. With this configuration, the fluctuation component of the voltage signal of the auxiliary winding inputted to the current controller and the fluctuation component of the signal based on the current flowing to the light source can be easily cancelled out by adjusting the resistance of the resistor.

With the power supply circuit pertaining to the above aspect, the primary winding of the transformer includes a filter winding that is configured to remove noise from the AC power supply. With this configuration, noise in the AC power supply can be more easily eliminated by the filter winding of the transformer.

With the power supply circuit pertaining to the above aspect, the light source includes an LED element provided to an LED bulb. The LED bulb takes up less space for mounting the element. With this configuration, the fluctuation component of the current flowing to the light source and the fluctuation component of the voltage of the auxiliary winding (AC power supply) are reduced by the current controller, which keeps the device from becoming larger. Therefore, flickering can be suppressed even with the LED bulb that takes up less space for mounting the element.

With the present disclosure, as discussed above, flickering that originates in the fluctuation component of an AC power supply can be suppressed while keeping the device or circuit from becoming larger.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only a preferred embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiment according to the present invention are provided for illustration only, and not for the purpose of limiting the invention as defined by the appended claims and their equivalents.

What is claimed is:

1. A power supply circuit comprising:
a rectifying circuit configured to rectify power of an AC power supply and supply the power to a light source;
a transformer electrically disposed between the AC power supply and the rectifying circuit, the transformer including a primary winding and an auxiliary winding; and
a current controller configured to adjust an amount of current flowing to the light source by detecting a voltage signal of the auxiliary winding and a signal based on the current flowing to the light source.

2. The power supply circuit according to claim 1, wherein
the current controller is configured such that voltage of the auxiliary winding is inputted as voltage for driving the current controller, independently from the voltage signal of the auxiliary winding detected for adjusting the amount of current flowing to the light source.

3. The power supply circuit according to claim 1, wherein
the current controller is configured such that the current flowing to the light source is adjusted lower while the voltage signal of the auxiliary winding and the signal based on the current flowing to the light source become larger, and such that the current flowing to the light source is adjusted higher while the voltage signal of the auxiliary winding and the signal based on the current flowing to the light source become smaller.

4. The power supply circuit according to claim 1, wherein
the current controller is configured such that the voltage signal of the auxiliary winding and the signal based on the current flowing to the light source are superposed and inputted.

5. The power supply circuit according to claim 1, further comprising
a resistor electrically disposed between the auxiliary winding and the current controller, the resistor being configured to adjust a size of the voltage signal of the auxiliary winding inputted to the current controller.

6. The power supply circuit according to claim 1, wherein
the primary winding of the transformer includes a filter winding that is configured to remove noise from the AC power supply.

7. The power supply circuit according to claim 1, wherein
the light source includes an LED element provided to an LED bulb.

8. The power supply circuit according to claim 2, wherein
the current controller has first and second terminals, the voltage of the auxiliary winding is inputted to the first terminal, the voltage signal of the auxiliary winding is inputted to the second terminal.

9. The power supply circuit according to claim 5, wherein
the resistor has a resistance that is adjusted such that fluctuation component of the voltage signal of the auxiliary winding and fluctuation component of the signal based on the current flowing to the light source cancel each other.

10. An illumination device comprising:
a light source; and
a power supply circuit electrically coupled to the light source, the power supply circuit including
a rectifying circuit configured to rectify power of an AC power supply and supply the power to the light source,
a transformer electrically disposed between the AC power supply and the rectifying circuit, the transformer including a primary winding and an auxiliary winding, and
a current controller configured to adjust an amount of current flowing to the light source by detecting a voltage signal of the auxiliary winding and a signal based on the current flowing to the light source.
